(19) United States
(12) Patent Application Publication
(10) Pub. No.: US 2026/0211589 A1
(43) Pub. Date: Jul. 23, 2026

(54) RECORDING APPARATUS

(71) Applicant: CANON FINETECH NISCA INC., Saitama (JP)

(72) Inventors: Kunihide SUZUKI, Saitama (JP); HIirohisa NIIDA, Tokyo (JP); Ryo MIDORIKAWA, Saitama (JP); Noritaka NAKASHIMA, Saitama (JP); Naoki NINOMIYA, Saitama (JP)

(21) Appl. No.: 19/568,239

(22) Filed: Mar. 16, 2026

Related U.S. Application Data
(63) Continuation of application No. PCT/JP2024/034202, filed on Sep. 25, 2024.

(30) Foreign Application Priority Data
Sep. 25, 2023 (JP) 2023-160039
Sep. 25, 2024 (JP) 2024-166170

(51) Int. Cl. G06F 3/12; B41J 3/407; B41J 11/00; G06F 11/07

(52) U.S. Cl. CPC G06F 3/121; B41J 3/4075; B41J 11/0095; G06F 11/0769

(57) ABSTRACT

A recording apparatus in which a user can move a light-emitting portion and a light-receiving portion of a transmissive sensor in a width direction of a label includes execution means configured to be able to select a position adjustment mode and configured to execute the position adjustment mode in which, while the user has selected the position adjustment mode, notification means is caused to perform a notification when positions of the light-emitting portion and the light-receiving portion are not aligned, and the notification means is not caused to perform a notification when the positions of the light-emitting portion and the light-receiving portion are aligned.

### CROSS-REFERENCE TO RELATED APPLICATIONS

This application is a Continuation of International Patent Application No. PCT/JP2024/034202, filed Sep. 25, 2024, which claims the benefit of Japanese Patent Application No. P2023-160039, filed Sep. 25, 2023 and Japanese Patent Application No. P2024-166170, filed Sep. 25, 2024, each of which is hereby incorporated by reference herein in their entirety.

### BACKGROUND OF THE INVENTION

### Field of the Invention

The present invention relates to a recording apparatus that performs recording on a label affixed to a sheet.

### Description of the Related Art

In a case where images are sequentially recorded on a large number of labels affixed to long backing paper at regular intervals, it is necessary to detect a leading edge of the label being conveyed in order to specify a recording start position. As a configuration for detecting the leading edge of the label, a transmissive sensor in which a light-emitting portion and a light-receiving portion are arranged to face each other with the recording medium being conveyed in between has conventionally been used, and the leading edge of the label is detected based on a difference in transmitted light quantity between a part of only the backing paper and a part where the label is affixed to the backing paper.

At this time, as long as the label has a general rectangular shape, the leading edge of the label can be easily detected even if the transmissive sensor is disposed at any position within a range in a width direction of the label. However, in the case of an irregular label other than a rectangle, there is a possibility that it is not possible to correctly detect the leading edge of the label depending on the position of the transmissive sensor in the width direction of the label.

Therefore, a configuration in which the light-emitting portion and the light-receiving portion are respectively configured to be slidable in the width direction of the label, and the light-emitting portion and the light-receiving portion are moved according to the type of paper has been disclosed (Japanese Patent Laid-Open No. 2018-69579).

According to this configuration, it is possible to correctly detect the leading edge of the label by positioning the transmissive sensor at the leading edge position of the label according to the label shape.

In Japanese Patent Laid-Open No. 2018-69579, if the positions of the light-emitting portion and the light-receiving portion are misaligned, a recording apparatus cannot detect a mark on the paper when the paper has been conveyed, and an error occurs.

After adjusting the positions of the light-emitting portion and the light-receiving portion, a user knows that the positions of the light-emitting portion and the light-receiving portion are misaligned by the recording apparatus starting paper conveyance and then an error occurring. Therefore, there is a problem that the user cannot know whether the light-emitting portion and the light-receiving portion are at state positions where the label can be detected, when the user adjusts the positions of the light-emitting portion and the light-receiving portion.

### SUMMARY OF THE INVENTION

The present invention has been made in view of the above problems, and an object of the present invention is to provide a recording apparatus capable of causing a user to know whether a light-emitting portion and a light-receiving portion are in a state of being able to detect a label when the user adjusts positions of the light-emitting portion and the light-receiving portion of a detection unit that detects the label with transmitted light.

In order to achieve the above object, a representative configuration according to the present invention includes: conveyance means configured to convey a label; a light-emitting portion provided to be movable in a width direction of the label and configured to emit light; a light-receiving portion provided to be movable in the width direction of the label and configured to receive the light from the light-emitting portion; a detection unit configured to detect a leading edge of the label conveyed by the conveyance means based on an output of the light-receiving portion; recording means configured to perform recording on the label based on a detection result of the detection unit; notification means configured to notify a user; and execution means configured to be able to select a position adjustment mode and configured to execute the position adjustment mode in which the notification means is caused to perform a notification when positions of the light-emitting portion and the light-receiving portion are not aligned while the user has selected the position adjustment mode, and the notification means is not caused to perform a notification when the positions of the light-emitting portion and the light-receiving portion are aligned while the user has selected the position adjustment mode.

Further features of the present invention will become apparent from the following description of exemplary embodiments with reference to the attached drawings.

### BRIEF DESCRIPTION OF THE DRAWINGS

FIG. 1 is a view illustrating an appearance of a recording apparatus.

FIG. 2 is a cross-sectional view illustrating a schematic configuration of the recording apparatus.

FIG. 3 is an explanatory view of a label sheet.

FIG. 4 is a control block diagram of the recording apparatus.

FIG. 5 is a view illustrating a configuration of a light-emitting unit.

FIG. 6 is a view illustrating a configuration of a light-receiving unit.

FIG. 7 is a view illustrating a positional relationship among a recording head, a medium sensor, and a conveying roller.

FIG. 8 is a view illustrating detection of a rectangular label in a label sheet.

FIG. 9 is a view illustrating detection of a non-rectangular label in a label sheet.

FIGS. 10A to 10F are a layout view of a transmissive sensor upper/lower position alignment explanation screen displayed on an LCD of an operation portion of the recording apparatus.

FIG. 11 is a flowchart illustrating an example in which transmissive sensor upper/lower position alignment of the recording apparatus is performed.

FIGS. 12A and 12B are a layout view of a transmissive sensor upper/lower position alignment status display screen displayed on the LCD of the operation portion of the recording apparatus.

FIG. 13 is a view of an appearance of a recording apparatus in a second embodiment.

FIG. 14 is a view of the recording apparatus according to the second embodiment as viewed obliquely from behind.

FIG. 15 is a view of a state where a roll cover is opened in the recording apparatus in the second embodiment.

FIG. 16 is an enlarged view of a part of FIG. 15.

### DESCRIPTION OF THE EMBODIMENTS

### First Embodiment

Next, a recording apparatus according to a first embodiment of the present invention will be described with reference to the drawings.

### <Overall Configuration of Recording Apparatus>

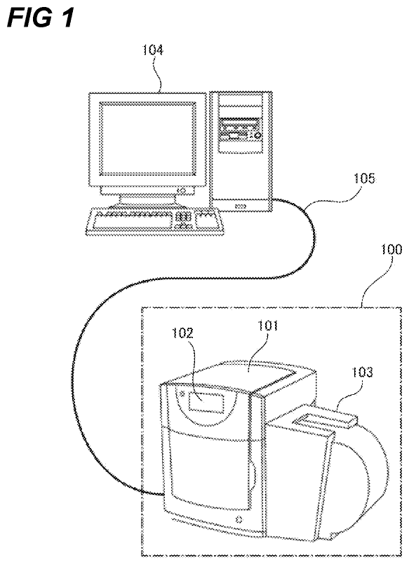

FIG. 1 is a perspective view illustrating a recording apparatus according to the present embodiment. A recording apparatus 100 includes an apparatus body 101 provided with an operation portion 102 including an LCD as a display panel and a touch panel, and a sheet holder 103 configured to load a label sheet in which a long sheet to which a label is affixed is wound in a roll shape. On the label sheet, a plurality of labels are affixed to a long sheet as backing paper at regular intervals.

The recording apparatus 100 prints image data received from a host computer 104 onto a label affixed to a label sheet while the label sheet is conveyed by conveyance means. The recording apparatus 100 and the host computer 104 are connected by a printer cable 105.

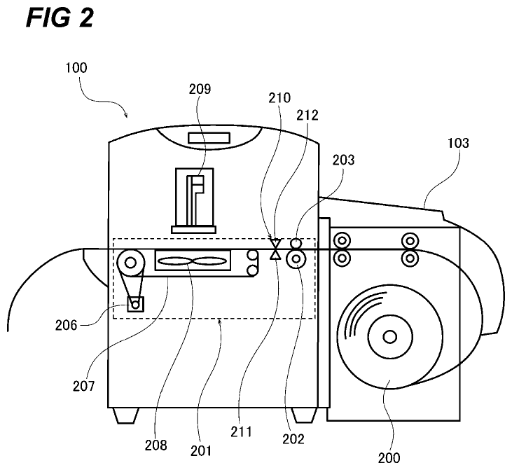

FIG. 2 is a schematic cross-sectional view of the recording apparatus 100. The recording apparatus 100 is configured to cause a conveyance unit 201 to convey a label sheet 200 as a recording medium loaded in the sheet holder 103. The label sheet 200 is conveyed by a conveying roller 202 and a pinch roller 203 of the conveyance unit 201 and a conveying belt 207 as conveyance means. A fan 208 is provided inside the conveyance unit 201, and the conveyance unit 201 conveys the label sheet 200 while sucking the label sheet 200 onto the conveying belt 207 by generating negative pressure with the fan 208.

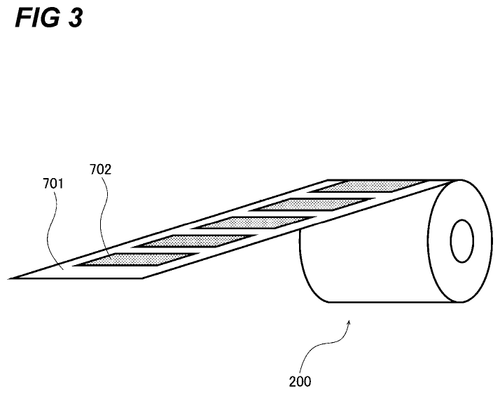

As illustrated in FIG. 3, the label sheet 200 as a recording medium is obtained by winding a continuous sheet in a roll shape, and labels 702 are affixed to long backing paper 701 at equal intervals. The recording apparatus 100 conveys the label sheet 200 and performs recording on the label 702.

The recording apparatus in the present embodiment is an inkjet recording apparatus including recording means configured to perform recording by discharging ink, and as illustrated in FIG. 2, a recording head 209 having a large number of nozzles that discharge ink is held to face a surface of the conveying belt 207 on which a recording medium is conveyed. An ink tank (not illustrated) is connected to the recording head 209. At the time of recording, an image is recorded on the label 702 by discharging ink from the recording head 209 according to an image signal onto the label sheet 200 conveyed by the conveyance unit 201.

A label detection sensor 210 capable of detecting the leading edge of the label 702 affixed to the label sheet 200 is disposed at a position upstream of the recording head 209 in a conveyance direction of the label sheet 200. The label detection sensor 210 in the present embodiment is a transmissive sensor configured by a combination of a light-emitting unit 211 including a light-emitting portion and a light-receiving unit 212 including a light-receiving portion. The transmissive sensor 210 performs irradiation with light from the light-emitting portion of the light-emitting unit 211, and the light-receiving portion of the light-receiving unit 212 receives the light transmitted through the label 702 of the label sheet 200. The light-receiving unit 212 outputs a signal corresponding to the intensity of the received light.

### <Controller>

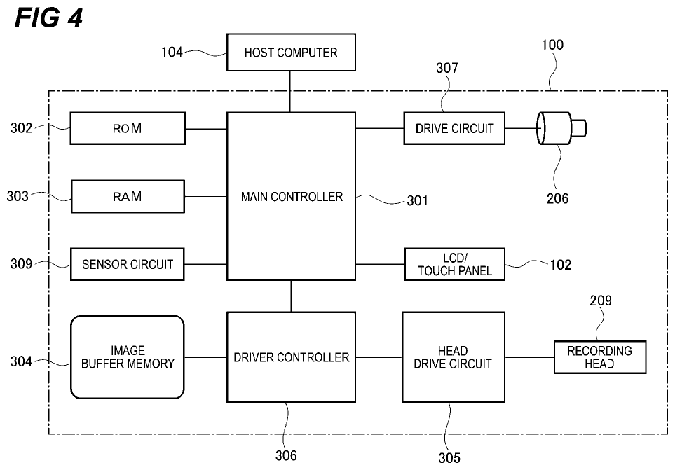

FIG. 4 is a block diagram illustrating a configuration of a controller that controls operations of the recording apparatus 100 in the present embodiment. The recording apparatus 100 executes a conveyance operation and a recording operation on the recording medium based on a control signal from the controller.

In FIG. 4, the reference sign 301 denotes a main controller that controls the entire recording apparatus, and has a function as storage means configured to store data, a function as data control means, a function as setting means configured to change the operation of the apparatus based on setting data, and the like. The main controller 301 is connected to the host computer 104 and exchanges signals with each other. The reference sign 302 denotes a ROM that is connected to the main controller 301 and in which a control program and the like are stored, and the main controller 301 uses the RAM 303 as a working memory according to these programs.

The reference sign 304 denotes an image buffer configured to store image data transmitted from the host computer 104. The reference sign 305 denotes a head drive circuit configured to drive a heating element built in the recording head 209, and a driver controller 306 connected to the main controller 301 controls the head drive circuit 305 based on bitmap format image data stored in the image buffer, thereby recording an image. The reference sign 307 denotes a drive circuit configured to drive a conveyance motor 206 provided in the conveyance unit 201, and is controlled by the main controller 301.

Then, a screen displayed on the LCD of the operation portion 102 and a behavior in a case where a user operates the touch panel of the operation portion 102 are also controlled by the main controller 301. Further, the main controller 301 receives a signal output from the light-receiving unit 212 of FIG. 2 via a sensor circuit 309. The main controller 301 detects the leading edge of the label 702 on the label sheet 200 based on a signal output from the light-receiving unit 212 when the label sheet 200 passes between the light-emitting unit 211 and the light-receiving unit 212, and sets a recording start timing on the label 702.

### <Movement Configuration of Light-Emitting Unit and Light-Receiving Unit>

The recording apparatus in the present embodiment is configured such that the light-emitting unit 211 and the light-receiving unit 212 can be appropriately moved according to the shape of the label so that a leading edge position of the label can be detected even in the case of an irregular label.

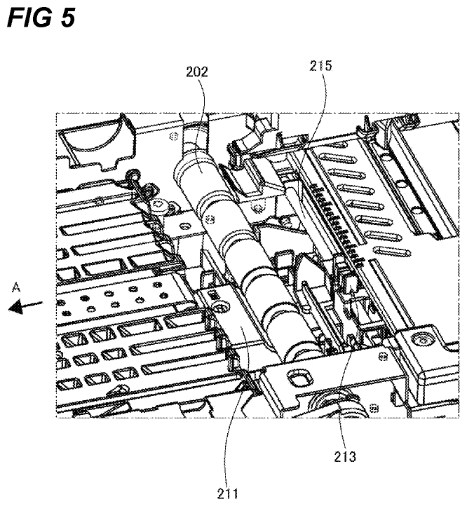

FIG. 5 is a view illustrating the light-emitting unit 211 of the transmissive sensor 210. The light-emitting unit 211 includes a light-emitting portion. The light-emitting unit 211 is connected to a first knob 213 that is an operation portion operated by a user. The first knob 213 is movable along a first shaft 215. The first shaft is disposed along a direction perpendicular to the conveyance direction (arrow A). When the user operates the first knob 213, the light-emitting unit 211 moves along the first shaft 215.

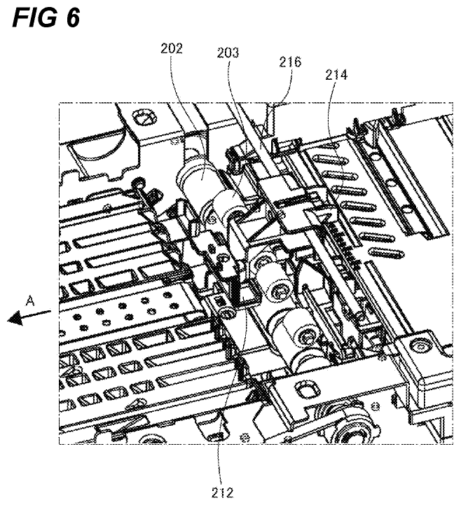

FIG. 6 is a view illustrating the light-receiving unit 212 of the transmissive sensor 210. The light-receiving unit 212 including a light-receiving portion is located above the light-emitting unit 211. The light-receiving unit 212 is connected to a second knob 214 that is an operation portion operated by a user. The second knob 214 is movable along a second shaft 216. The second shaft 216 is disposed in parallel with the first shaft 215. When the user operates the second knob 214, the light-receiving unit 212 moves along the second shaft 216. Note that, even if there is no specific operation portion operated by the user, it is sufficient that the user can move the light-emitting portion and the light-receiving portion along the width direction of the label.

When the light-emitting unit 211 is caused to emit light in a state where the light-emitting portion of the light-emitting unit 211 and the light-receiving portion of the light-receiving unit 212 face each other, the light-receiving unit 212 outputs a signal corresponding to the light quantity received from the light-emitting unit 211.

Note that the first shaft 215 and the second shaft 216 are disposed along a direction (width direction of a recording medium) that is perpendicular to the conveyance direction (arrow A) and is perpendicular to a direction in which the light-emitting unit 211 and the light-receiving unit 212 face each other.

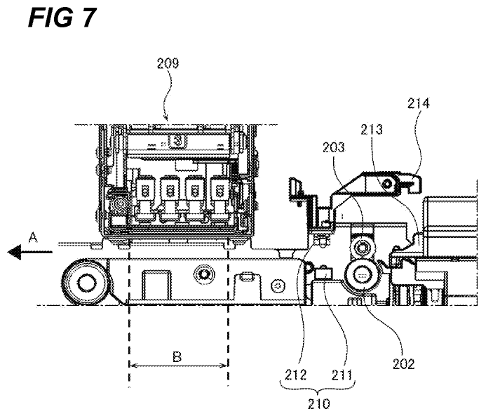

FIG. 7 is a view illustrating a positional relationship among the transmissive sensor 210, the recording head 209, and the conveying roller 202. The transmissive sensor 210 is disposed upstream of the recording head 209 and downstream of the conveying roller 202 in the conveyance direction A of the label sheet 200. Since it is necessary to set a recording start timing by the recording head 209 after detecting the position of the leading edge (downstream end portion) of the label 702, the transmissive sensor 210 needs to be located on the upstream side of the recording head 209, in other words, on the upstream side of an area B where the recording head performs recording.

In addition, in order to accurately convey the label 702 to the area B after the transmissive sensor 210 detects the label 702, it is advantageous that a distance between the transmissive sensor 210 and the area B is short. This is because the longer a distance for conveying the label sheet 200 to the area B after the transmissive sensor 210 detects the label, the more easily the label sheet is affected by the variation in conveyance accuracy of the conveyance unit 201.

Therefore, by arranging the transmissive sensor 210 in the direction along the conveyance direction A of the label sheet on the upstream side of the recording head 209 and on the downstream side of the conveying roller 202, the label sheet 200 can be accurately conveyed, and a recorded image can be formed at a correct position with respect to the label 702.

Note that the first knob 213 and the second knob 214 are disposed upstream of the conveying roller 202 in the conveying direction (arrow A). With such an arrangement, a space for the user to operate the knob can be easily secured, and operability can be improved.

In addition, when the label passes between the light-emitting unit 211 and the light-receiving unit 212, the transmissive sensor 210 detects the leading edge of the label by a change in the received light quantity of the light-receiving unit 212. Depending on the thickness of the label, light emitted from the light-emitting portion of the light-emitting unit 211 may be completely blocked by the label. Even in this case, the output of the light-receiving unit 212 is different between a state where there is no label and a state where there is a label between the light-emitting portion of the light-emitting unit 211 and the light-receiving portion of the light-receiving unit 212. Therefore, the leading edge of the label can be detected from the change in the output of the light-receiving unit 212.

### <Movement of Light-Emitting Unit and Light-Receiving Unit>

Next, a configuration for moving the light-emitting unit 211 and the light-receiving unit 212 that are movable as described above to positions facing each other will be described.

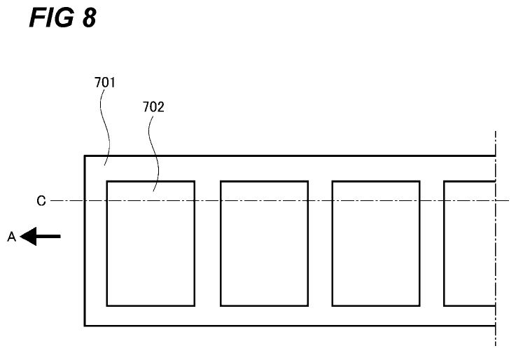

FIG. 8 is a view illustrating a case where the label 702 affixed to backing paper 701 of the label sheet 200 has a rectangular shape. In a case where the label 702 is rectangular, the timing of detecting the leading edge of the label 702 on the label sheet 200 conveyed in the direction of the arrow A is the same regardless of the position of the transmissive sensor 210, as long as the transmissive sensor 210 overlaps with the label 702 in the width direction. Therefore, by performing detection by the transmissive sensor 210 disposed at a position C overlapping the label 702 in the width direction, a recording start timing for the label 702 can be correctly set.

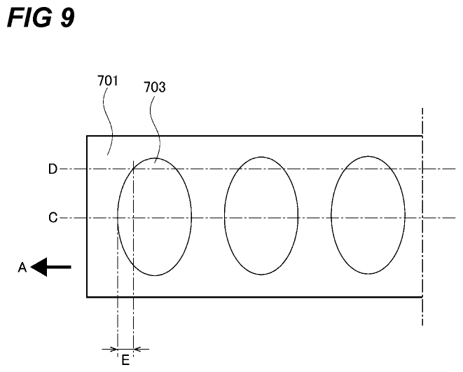

On the other hand, FIG. 9 is a view illustrating a case of an irregular label 703 that has a non-rectangular shape and is affixed to the backing paper 701 of the label sheet 200. A difference of E occurs at a detection timing when the transmissive sensor 210 disposed at the position C of the irregular label 703 conveyed in the direction of the arrow A performs detection and a detection timing when the transmissive sensor 210 disposed at a leading edge position D of the irregular label 703 in the conveyance direction performs detection.

Therefore, when detection is performed by the transmissive sensor 210 located at the position C, the recording start timing for the irregular label 703 cannot be set correctly. On the other hand, in a case where recording is performed on the irregular label 703, it is possible to correctly set the recording start timing for the irregular label 703 by the user moving the light-emitting unit 211 and the light-receiving unit 212 of the transmissive sensor 210 to the position D.

However, as described above, when the user moves the light-emitting unit 211 and the light-receiving unit 212 to a predetermined position in the label width direction, it is not easy to visually align the positions of both the units 211 and 212 to achieve a positional relationship in which the label can be detected. Therefore, in the present embodiment, a notification of whether or not the positions of the light-emitting portion of the light-emitting unit 211 and the light-receiving portion of the light-receiving unit 212 are aligned is performed.

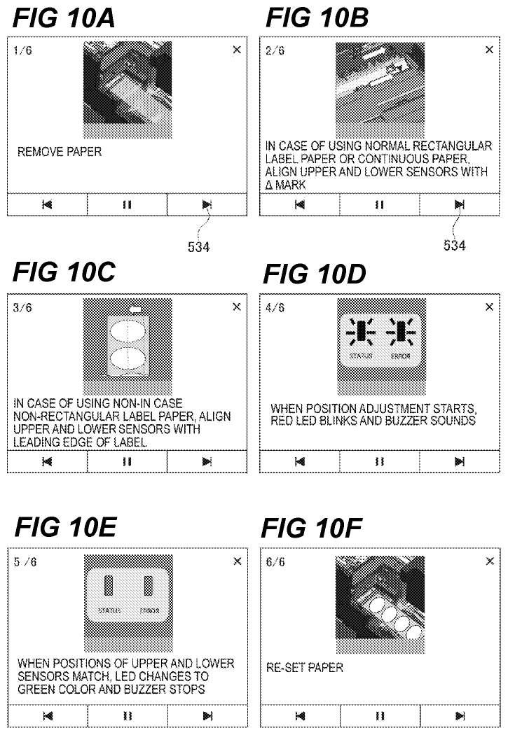

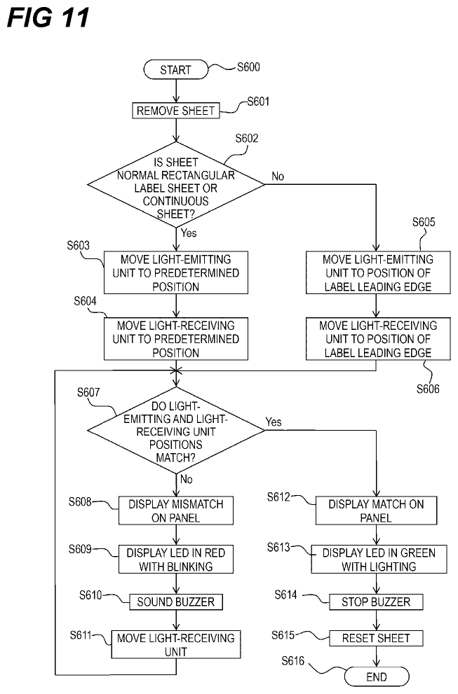

Specifically, when the user moves the light-emitting unit 211 and the light-receiving unit 212 to align them, if the user taps “transmissive sensor upper/lower position alignment key” on a display screen displayed on the LCD of the operation portion 102, the recording apparatus 100 enters a position adjustment mode, and an explanation screen indicating the procedure of the transmissive sensor upper/lower position alignment illustrated in FIGS. 10A to 10F is displayed on the display screen of the LCD. When the user executes the transmissive sensor upper/lower position alignment, the position alignment control of the transmissive sensor is executed according to the procedure of the flowchart illustrated in FIG. 11. Note that the transmissive sensor upper/lower position alignment refers to aligning the positions of the light-receiving portion of the light-receiving unit 212 located on the upper side of a conveyance path of the label sheet 200 and the light-emitting portion of the light-emitting unit 211 located on the lower side, in the width direction of the label sheet 200.

The explanation displayed on the display screen of the operation portion 102 is sequentially switched when a predetermined time elapses or a next key 534 (see FIG. 10 A to 10F) is tapped to explain an alignment operation. In the present embodiment, in a case where the label sheet (paper) 200 has been set in the recording apparatus 100 when the transmissive sensor upper/lower position alignment is started, it is displayed that the label sheet 200 is to be removed from the recording apparatus 100 (FIG. 10A). In a case where the label sheet 200 set by the user has a rectangular label affixed thereto, the explanation prompts the user to move the transmissive sensor 210 to a predetermined position where the label can be detected (a position of a triangle mark illustrated in FIG. 10B in the present example), and in a case where the affixed label is an irregular label that is not rectangular, an explanation to move the transmissive sensor 210 to a leading edge position of the irregular label is displayed (FIG. 10C).

When the positions of the light-emitting portion of the light-emitting unit 211 and the light-receiving portion of the light-receiving unit 212 are not aligned, a red LED as notification means blinks, and an explanation screen indicating that a buzzer sounds is displayed (FIG. 10D). When the upper/lower positions of the light-emitting unit 211 and the light-receiving unit 212 are aligned, an explanation screen indicating that the LED turns on in green and the buzzer stops is displayed (FIG. 10E).

Finally, after the upper/lower position alignment of the transmissive sensor 210 is completed, an explanation screen prompting the user to set the label sheet (paper) 200 again is displayed (FIG. 10F).

The user performs alignment of the transmissive sensor according to the explanation as described above. A control procedure at that time will be described with reference to a flowchart of FIG. 11.

When the recording apparatus 100 enters the position adjustment mode, control for the user to perform position alignment between the light-emitting portion of the light-emitting unit 211 and the light-receiving portion of the light-receiving unit 212 is started (S600). In a case where the label sheet 200 is set on the recording apparatus 100 according to the display content of the LCD, the user removes the label sheet 200 from the recording apparatus 100 (S601). In addition, when the recording apparatus enters the position adjustment mode, the main controller 301 starts light emission from the light-emitting portion of the light-emitting unit 211.

In a case where the shape of the label affixed to the label sheet 200 set by the user is the rectangular label 702 (Yes in S602), the user first operates the second knob 214 to move the lower light-emitting unit 211 to a predetermined position (position C illustrated in FIG. 8) where the label can be detected (S603). The user then operates the first knob 213 to move the upper light-receiving unit 212 to a predetermined position where the label can be detected (S604).

On the other hand, in a case where the shape of the label affixed to the label sheet 200 set by the user is the irregular label 703 other than a rectangle (No in S602), the user operates the second knob 214 to move the light-emitting portion of the light-emitting unit 211 to the position of the leading edge of the irregular label 703 (position D illustrated in FIG. 9) (S605). The user then operates the first knob 213 to move the light-receiving portion of the light-receiving unit 212 to the position of the leading edge of the irregular label (S606).

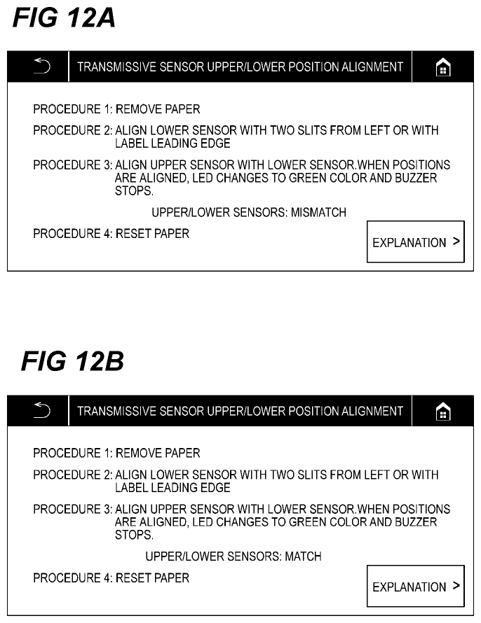

When the user moves the transmissive sensor 210 and the positions of the light-emitting unit 211 and the light-receiving unit 212 are not aligned (No in S607), a position-alignment status display screen, as illustrated in FIG. 12A, is displayed on the LCD. The display indicates “mismatch” when the light-emitting portion of the light-emitting unit 211 of the transmissive sensor 210 and the light-receiving portion of the light-receiving unit 212 are not in the positional relationship in which the label can be detected, and when the positions are not aligned (S608). The LED blinks in red (S609), and the buzzer sounds (S610) to notify the user. The user moves the upper light-receiving unit 212 until the positions of the light-emitting portion and the light-receiving portion of the transmissive sensor are aligned (S611).

On the other hand, in a case where the positions of the light-emitting portion of the light-emitting unit 211 and the light-receiving portion of the light-receiving unit 212 of the transmissive sensor are aligned, that is, in a case where the label can be detected (Yes in S607), the transmissive sensor position adjustment status display screen illustrated in FIG. 12B is displayed, the display indicating that the positions of the light-emitting unit 211 and the light-receiving unit 212 of the transmissive sensor 210 are aligned and the label can be detected is displayed as “match” (S612), the LED turns on in green (S613), and the buzzer stops (S614) to notify the user.

After the positions of the light-emitting portion of the light-emitting unit 211 and the light-receiving portion of the light-receiving unit 212 become the state where the label can be detected as described above, the user sets the label sheet 200 again (S615) and ends the position alignment process of the transmissive sensor (S616). When the sensor position alignment process is completed, the main controller 301 stops light emission from the light-emitting unit 211.

Here, when the light-emitting unit 211 and the light-receiving unit 212 are moved, whether or not both the units are in the positional relationship in which the label can be detected is determined by the light quantity received by the light-receiving portion of the light-receiving unit 212. Specifically, when the user moves the light-emitting unit 211 by executing the position adjustment of the transmissive sensor and then the user moves the light-receiving unit, and when the light-receiving portion of the light-receiving unit 212 detects the light quantity emitted from the light-emitting portion of the light-emitting unit 211, which is equal to or more than a preset threshold value, it is determined that the light-receiving portion of the light-receiving unit 212 and the light-emitting portion of the light-emitting unit 211 are in the positional relationship in which the label can be detected, and the positions of both the units are aligned. Conversely, when the light-receiving unit is moved and the light quantity detected by the light-receiving portion of the light-receiving unit 212 from the light-emitting portion of the light-emitting unit 211 is less than the threshold value, it is determined that the light-receiving portion of the light-receiving unit 212 and the light-emitting portion of the light-emitting unit 211 are not in the positional relationship in which the label can be detected and the positions of both the units are not aligned.

That is, whether or not the positions of the light-emitting unit 211 and the light-receiving unit 212 are aligned is determined by whether or not the light-receiving portion of the light-receiving unit 212 can receive the light quantity necessary for detecting the label 703. Therefore, even if the positions of the light-emitting portion of the light-emitting unit 211 and the light-receiving portion of the light-receiving unit 212 are not accurately aligned, as long as the light quantity necessary for detecting the label 703 can be received, it is determined that the positions of the light-emitting unit 211 and the light-receiving unit 212 are aligned. Even though the positions of the light-emitting portion of the light-emitting unit 211 and the light-receiving portion of the light-receiving unit 212 are shifted by about ±2 mm, the label detection sensor 210 can detect the label 703. Therefore, even though the deviation is about ±2 mm, it may be determined that the positions of the light-emitting portion of the light-emitting unit 211 and the light-receiving portion of the light-receiving unit 212 are aligned.

As described above, in the recording apparatus in the present embodiment, when the light-emitting unit 211 and the light-receiving unit 212 of the transmissive sensor 210 are moved, whether the position of the light-emitting portion of the light-emitting unit 211 and the position of the light-receiving portion of the light-receiving unit 212 are aligned or not is determined based on the light quantity received by the light-receiving portion of the light-receiving unit 212. When both the units 211 and 212 are not aligned in the position adjustment mode, the user is notified of the misalignment by sounding a buzzer or blinking LED in red, which serve as notification means. When the units are aligned, the user is notified of the alignment by stopping the buzzer and turning on the LED in green. That is, a notification enabling the user having ordinary eyesight and hearing ability to determine whether the light-emitting portion of the light-emitting unit 211 and the light-receiving portion of the light-receiving unit 212 are aligned or not is performed. As a result, the user can easily determine whether the positions of the light-emitting portion of the light-emitting unit 211 and the light-receiving portion of the light-receiving unit 212 are aligned or not, and can move the light-emitting unit and the light-receiving unit, by the notification from the notification means. That is, when the user adjusts the positions of the light-emitting portion and the light-receiving portion, the user can know whether the positions of the light-emitting portion and the light-receiving portion are aligned or not.

Note that, in the present example, the buzzer sounds when the light-emitting portion of the light-emitting unit 211 and the light-receiving portion of the light-receiving unit 212 are not aligned, and the buzzer is stopped when the positions are aligned, but this configuration may be reversed. That is, the buzzer may not sound when the positions of the light-emitting portion of the light-emitting unit 211 and the light-receiving portion of the light-receiving unit 212 are not aligned, and the buzzer may sound to notify the user when the positions are aligned. In addition, the buzzer sound when the positions are aligned and the buzzer sound when the positions are not aligned may be used to change the pitch or change the continuous sound or the intermittent sound.

In addition, in the present example, it is assumed that, when the positions of the light-emitting portion of the light-emitting unit 211 and the light-receiving portion of the light-receiving unit 212 are not aligned, the notification is performed by sounding the buzzer and blinking the LED in red. However, the notification content may be changed according to the shift amount between the positions of the light-emitting portion of the light-emitting unit 211 and the light-receiving portion of the light-receiving unit 212. For example, according to a decrease in the shift amount between the positions of the light-emitting portion of the light-emitting unit 211 and the light-receiving portion of the light-receiving unit 212, the interval of the buzzer sound is narrowed, the pitch of the buzzer sound is increased, the period of red blinking of the LED is shortened, the color development of the LED is changed, or the display content of the LCD is changed. As a result, the user can know whether the shift amount between the positions of the light-emitting portion of the light-emitting unit 211 and the light-receiving portion of the light-receiving unit 212 is large or small.

Furthermore, in the present embodiment, a case where the user is notified by using the LED has been described, but other light emitters such as a light bulb may be used.

Furthermore, in the present embodiment, the operation portion operated by the user to move the light-emitting unit 211 and the operation portion to move the light-receiving unit 212 are provided as knobs, but a dial for moving the light-emitting unit 211 and a dial for moving the light-receiving unit 212 may be provided by using the operation portion as a dial.

### Second Embodiment

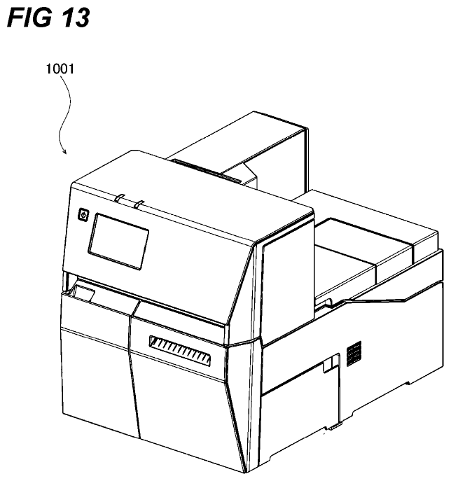

A second embodiment will be described with reference to FIGS. 13 to 16.

FIG. 13 is a perspective view illustrating an external view of a recording apparatus 1001 according to the present embodiment. The recording apparatus 1001 includes a roll cover 1002 that can be opened and closed by a user.

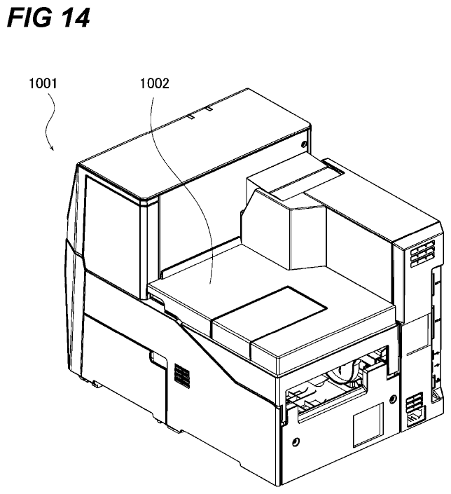

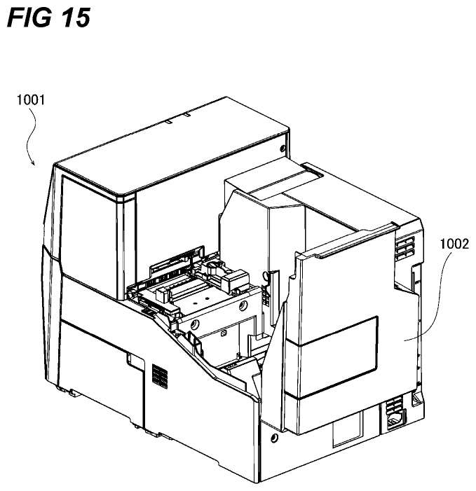

FIGS. 14 and 15 are perspective views of the recording apparatus 1001 as viewed obliquely from the rear. FIG. 14 illustrates a state where the roll cover 1002 is closed, and FIG. 15 illustrates a state where the roll cover 1002 is opened. When the user sets a roll-shaped label sheet 200 in the recording apparatus 1001, the user opens the roll cover 1002 and sets a label sheet 200 in a state where a conveyance path of the label sheet 200 is exposed.

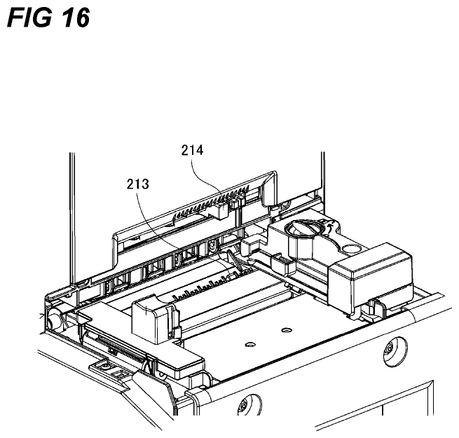

FIG. 16 is an enlarged view of a part of FIG. 15, and is an enlarged view of the periphery of a first knob 213 and a second knob 214. In addition, the recording apparatus 1001 includes a cover opening/closing sensor (not illustrated) capable of detecting whether the roll cover 1002 is opened or closed.

In a state where the roll cover 1002 is closed as illustrated in FIG. 14, the first knob 213 and the second knob 214 are covered with the roll cover 1002. In this state, the user cannot operate the first knob 213 and the second knob 214. On the other hand, in a state where the roll cover 1002 is opened as illustrated in FIGS. 15 and 16, the first knob 213 and the second knob 214 are exposed. In the state illustrated in FIGS. 15 and 16, the user can operate the first knob 213 and the second knob 214.

In the present embodiment, a main controller 301 performs a notification of whether or not positions of a light-emitting portion of a light-emitting unit 211 and a light-receiving portion of a light-receiving unit 212 are aligned, when the roll cover 1002 is opened in a state where the recording apparatus 1001 is powered on. The notification is performed by a method according to the first embodiment.

When the user operates the first knob 213 and the second knob 214, the roll cover 1002 is opened. That is, when the roll cover 1002 is opened in a state where the recording apparatus 1001 is powered on, there is a possibility that the positions of the light-emitting portion of the light-emitting unit 211 and the light-receiving portion of the light-receiving unit 212 are shifted by an operation of the user. Therefore, when the roll cover 1002 is opened in a state where the recording apparatus 1001 is powered on, the light-emitting portion of the light-emitting unit 211 is caused to emit light, and thus it is determined whether the positions of the light-emitting portion of the light-emitting unit 211 and the light-receiving portion of the light-receiving unit 212 are aligned or not, and the user is notified of the determination.

As a result, when the roll cover 1002 is opened, that is, when the user can move the light-emitting unit 211 and the light-receiving unit 212, the user can know whether the positions of the light-emitting portion of the light-emitting unit 211 and the light-receiving portion of the light-receiving unit 212 are aligned or not.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

What is claimed is:

1. A recording apparatus comprising:
conveyance means configured to convey a label;
a light-emitting portion provided to be movable in a width direction of the label and configured to emit light;
a light-receiving portion provided to be movable in the width direction of the label and configured to receive the light from the light-emitting portion;
a detection unit configured to detect a leading edge of the label conveyed by the conveyance means based on an output of the light-receiving portion;
recording means configured to perform recording on the label based on a detection result of the detection unit;
notification means configured to notify a user; and
execution means configured to be able to select a position adjustment mode and configured to execute the position adjustment mode in which the notification means is caused to perform a notification when positions of the light-emitting portion and the light-receiving portion are not aligned while the user has selected the position adjustment mode, and the notification means is not caused to perform a notification when the positions of the light-emitting portion and the light-receiving portion are aligned while the user has selected the position adjustment mode.

2. A recording apparatus comprising:
conveyance means configured to convey a label;
a light-emitting portion provided to be movable in a width direction of the label and configured to emit light;
a light-receiving portion provided to be movable in the width direction of the label and configured to receive the light from the light-emitting portion;
a detection unit configured to detect a leading edge of the label conveyed by the conveyance means based on an output of the light-receiving portion;
recording means configured to perform recording on the label based on a detection result of the detection unit;
notification means configured to notify a user; and
execution means configured to be able to select a position adjustment mode and configured to execute the position adjustment mode in which the notification means is caused to perform a notification when positions of the light-emitting portion and the light-receiving portion are aligned while the user has selected the position adjustment mode, and the notification means is not caused to perform a notification when the positions of the light-emitting portion and the light-receiving portion are not aligned while the user has selected the position adjustment mode.

3. A recording apparatus comprising:
conveyance means configured to convey a label;
a light-emitting portion provided to be movable in a width direction of the label and configured to emit light;
a light-receiving portion provided to be movable in the width direction of the label and configured to receive the light from the light-emitting portion;
a detection unit configured to detect a leading edge of the label conveyed by the conveyance means based on an output of the light-receiving portion;
recording means configured to perform recording on the label based on a detection result of the detection unit;
notification means configured to notify a user; and
execution means configured to be able to select a position adjustment mode and configured to execute the position adjustment mode in which the notification means is caused to perform a first notification when positions of the light-emitting portion and the light-receiving portion are aligned while the user has selected the position adjustment mode, and the notification means is caused to perform a second notification different from the first notification when the positions of the light-emitting portion and the light-receiving portion are not aligned while the user has selected the position adjustment mode.

4. The recording apparatus according to any one of claims 1 to 3, wherein the notification means is a buzzer.

5. The recording apparatus according to any one of claims 1 to 3, wherein the notification means is an LED.

6. The recording apparatus according to claim 3, wherein the notification means is display on a display.

7. The recording apparatus according to claim 1, wherein the notification means changes the notification according to a distance between the light-emitting portion and the light-receiving portion when the light-emitting portion and the light-receiving portion are not in a detectable state.

8. The recording apparatus according to claim 3, wherein the notification means changes the second notification according to a distance between the light-emitting portion and the light-receiving portion when the light-emitting portion and the light-receiving portion are not in a detectable state.

9. A recording apparatus comprising:
conveyance means configured to convey a label;
a light-emitting portion provided to be movable in a width direction of the label and configured to emit light;
a light-receiving portion provided to be movable in the width direction of the label and configured to receive the light from the light-emitting portion;
a detection unit configured to detect a leading edge of the label conveyed by the conveyance means based on an output of the light-receiving portion;
recording means configured to perform recording on the label based on a detection result of the detection unit;
a cover configured to be openable/closable, the cover in which
a user is able to move the light-emitting portion and the light-receiving portion along the width direction of the label when the cover is opened, and
the user is not able to move the light-emitting portion and the light-receiving portion along the width direction of the label when the cover is closed;
open/close detection means configured to detect whether the cover is opened or closed;
notification means configured to notify the user; and
control means configured to perform control such that
when the cover is opened and positions of the light-emitting portion and the light-receiving portion are not aligned, the notification means is caused to perform a notification,
when the cover is opened and the positions of the light-emitting portion and the light-receiving portion are aligned, the notification means is not caused to perform a notification, and
when the cover is closed, the notification means is not caused to perform a notification.

10. A recording apparatus comprising:
conveyance means configured to convey a label;
a light-emitting portion provided to be movable in a width direction of the label and configured to emit light;
a light-receiving portion provided to be movable in the width direction of the label and configured to receive the light from the light-emitting portion;
a detection unit configured to detect a leading edge of the label conveyed by the conveyance means based on an output of the light-receiving portion;
recording means configured to perform recording on the label based on a detection result of the detection unit;
notification means configured to notify a user; and
execution means configured to be able to select a position adjustment mode and configured to execute the position adjustment mode in which the notification means is caused to perform a notification for causing the user to determine whether positions of the light-emitting portion and the light-receiving portion are aligned or not, while the user has selected the position adjustment mode.
